(19) United States
(12) Patent Application Publication
(10) Pub. No.: US 2018/0136502 A1
(43) Pub. Date: May 17, 2018

(54) TOUCH-SENSOR-EQUIPPED LIQUID CRYSTAL DISPLAY DEVICE

(71) Applicant: SHARP KABUSHIKI KAISHA, Sakai City. Osaka (JP)

(72) Inventors: JEAN MUGIRANEZA, Sakai City (JP); HIROYUKI OGAWA, Sakai City (JP); KAZUTOSHI KIDA, Sakai City (JP); KENSHI TADA, Sakai City (JP); SHINJI YAMAGISHI, Sakai City (JP)

(73) Assignee: Sharp Kabushiki Kaisha, Sakai City, Osaka (JP)

(21) Appl. No.: 15/564,254

(22) PCT Filed: Mar. 31, 2016
(86) PCT No.: PCT/JP2016/060706

§ 371 Date: Oct. 4, 2017

(30) Foreign Application Priority Data
Apr. 6, 2015 (JP) 2015-077929

(51) Int. Cl. G02F 1/1333; G02F 1/1335; G02F 1/1343; G06F 3/041; G06F 3/044

(52) U.S. Cl. CPC G02F 1/13338; G02F 1/133514; G02F 1/133512; G02F 1/134309; G02F 1/133345; G02F 2201/123; G06F 3/0416; G06F 3/044; G06F 2203/04107; G06F 2203/04112; G02F 2201/121; G06F 3/0412

(57) ABSTRACT

Provided is a touch-sensor-equipped liquid crystal display device in which touch sensors have an improved response speed, with the degradation of image quality being suppressed. A touch-sensor-equipped liquid crystal display device includes: a substrate 1 on which a common electrode 2 and a plurality of pixel electrodes 4 are provided; a color filter substrate 11 that is provided so as to be opposed to the substrate 1, wherein color filters 9 formed at positions corresponding to the pixel electrodes 4, respectively, and a black matrix 10 having openings at positions corresponding to the pixel electrodes 4, respectively, are formed on the color filter substrate 11; a liquid crystal layer 5 provided between the electrode substrate 1 and the color filter substrate 11; a drive electrode 7 that is arranged between the liquid crystal layer 5 and the color filter substrate 11, on or under the black matrix 10; a detection electrode 12 that forms an electrostatic capacitance between the same and the drive electrode 7; and a conductive body 8 that is arranged between the liquid crystal layer 5 and the detection electrode 12, on or under the color filters 9.

### TECHNICAL FIELD

The present invention relates to a touch-sensor-equipped liquid crystal display device.

### BACKGROUND ART

Patent Document 1 discloses a touch-sensor-equipped display device provided with touch sensors of an electrostatic-capacitance type. This touch-sensor-equipped display device has the following configuration: a common electrode provided so as to be opposed to display pixel electrodes is used as an electrode that doubles as a drive electrode of a pair of touch sensor electrodes, the pair being composed of this drive electrode and a detection electrode; and a driving voltage for display, which is applied to the common electrode, is used as a driving signal for touch sensors. This makes it unnecessary to additionally provide drive electrodes, thereby simplifying the structure.

### PRIOR ART DOCUMENT

### Patent Document

Patent Document 1: U.S. Pat. No. 8,786,557

### SUMMARY OF THE INVENTION

### Problem to be Solved by the Invention

In the conventional touch-sensor-equipped display device, however, the load capacity increases and the response time constant increases, since the flat-plate-type common electrode doubles as the drive electrode of the touch sensor electrodes. Further, since the driving voltage for display, which is applied to the common electrode, is used as the driving signal for the touch sensors, the response speed of the touch panel depends on the timing of the application of the driving voltage for display in the display device.

It is an object of the present invention to provide a touch-sensor-equipped liquid crystal display device in which the response speed of the touch sensors is improved while the degradation of the image quality is prevented.

### Means to Solve the Problem

A touch-sensor-equipped liquid crystal display device in one embodiment of the present invention includes: an electrode substrate on which a common electrode and a plurality of pixel electrodes are provided; a color filter substrate that is provided so as to be opposed to the electrode substrate, wherein color filters formed at positions corresponding to the pixel electrodes, respectively, and a black matrix having openings at positions corresponding to the pixel electrodes, respectively, are formed on the color filter substrate; a liquid crystal layer provided between the electrode substrate and the color filter substrate; a drive electrode that is arranged between the liquid crystal layer and the color filter substrate, on or under the black matrix; a detection electrode that is paired with the drive electrode, for detecting a change in an electrostatic capacitance formed between the detection electrode and the drive electrode; and a conductive body that is arranged between the liquid crystal layer and the detection electrode, on or under the color filters.

### Effect of the Invention

With the present invention, the response speed of the touch sensors can be improved while the degradation of the image quality is prevented.

### BRIEF DESCRIPTION OF DRAWINGS

FIG. 1 illustrates a cross-sectional structure of principal parts of a touch-sensor-equipped liquid crystal display device in Embodiment 1.

FIG. 2 is a cross-sectional view for explaining positions where drive electrodes are arranged, the cross-sectional view being taken along line in FIG. 1.

FIG. 3 is a top view in a case where detection electrodes are in a mesh shape.

FIG. 4A schematically illustrates an electric field (lines of electric force generated in a case where no dummy electrode is provided.

FIG. 4B schematically illustrates an electric field generated in a case where dummy electrodes are provided.

FIG. 5 illustrates data obtained by experiments of the magnitudes of signals detected by the touch sensors, to show differences between the case where dummy electrodes are provided and the case where no dummy electrode is provided.

FIG. 6 illustrates a cross-sectional structure of principal parts of a touch-sensor-equipped liquid crystal display device in Embodiment 2.

FIG. 7 is a cross-sectional view taken along line VII-VII in FIG. 6.

FIG. 8 illustrates a cross-sectional structure of principal parts of a modification configuration of the touch-sensor-equipped liquid crystal display device in Embodiment 2.

FIG. 9 illustrates a cross-sectional structure of principal parts of a touch-sensor-equipped liquid crystal display device in Embodiment 3.

FIG. 10 is a cross-sectional view taken along line X-X in FIG. 9.

FIG. 11 illustrates a cross-sectional structure of principal parts of a modification configuration of the touch-sensor-equipped liquid crystal display device in Embodiment 3.

FIG. 12 illustrates a cross-sectional structure of principal parts of a touch-sensor-equipped liquid crystal display device in Embodiment 4.

FIG. 13 is a cross-sectional view taken along line XIII-XIII in FIG. 12.

FIG. 14 illustrates a configuration in which, of dummy electrodes 8a, 8b, and 8c, only the dummy electrodes 8a and 8c are electrically connected, and of dummy electrodes 8d, 8e, and 8f, only the dummy electrodes 8d and 8f are electrically connected.

### MODE FOR CARRYING OUT THE INVENTION

A touch-sensor-equipped liquid crystal display device in one embodiment of the present invention includes: an electrode substrate on which a common electrode and a plurality of pixel electrodes are provided; a color filter substrate that is provided so as to be opposed to the electrode substrate, the color filter substrate including color filters formed at positions corresponding to the pixel electrodes, respectively, and a black matrix having openings at positions corresponding to the pixel electrodes; a liquid crystal layer provided between the electrode substrate and the color filter substrate; a drive electrode that is arranged between the liquid crystal layer and the color filter substrate, on or under the black matrix; a detection electrode that is paired with the drive electrode, for detecting a change in an electrostatic capacitance formed between the detection electrode and the drive electrode; and a conductive body that is arranged between the liquid crystal layer and the detection electrode, on or under the color filters (the first configuration).

According to the first configuration, each drive electrode of the touch sensors is formed in a thin line shape arranged on or under the black matrix, whereby the load capacity can be reduced as compared with the configuration in which the drive electrode is arranged over an entirety of the substrate, whereby the response time constant can be decreased. This makes it possible to improve the response speed of the touch sensors. Further, by arranging the conductive body between the liquid crystal layer and the detection electrode, on or under the color filters, the conductive body functions to shield the detection electrode and the common electrode from each other. This prevents an electric field from being applied to the liquid crystal layer, whereby the degradation of the image quality can be suppressed.

The first configuration may further include an insulator arranged between the color filter substrate and the liquid crystal layer (the second configuration).

According to the second configuration, the insulator functions to shield the detection electrode and the common electrode from each other. This prevents an electric field from being applied to the liquid crystal layer, thereby making it possible to further surely suppress the degradation of the image quality.

The first or second configuration may be further characterized in that the conductive body is provided in the same layer as that where the drive electrode is provided (the third configuration).

Alternatively, the first or second configuration may be characterized in that the conductive body is provided in a layer different from that where the drive electrode is provided (the fourth configuration).

Any one of the first to third configurations may be characterized in that the conductive body functions also as a second detection electrode that is paired with the drive electrode, for detecting a change in an electrostatic capacitance formed between the conductive body and the second drive electrode (the fifth configuration).

According to the fifth configuration, the approach or the contact of an object can be detected by using the second drive electrode and the conductive body, and when the approach or the contact of an object is detected, a detailed position of the contact of the object can be identified by using the drive electrode and the detection electrode. In the case of this method, the electric power consumption can be reduced, as compared with the method of detecting the contact position of an object by using the drive electrode and the detection electrode at all times.

The fifth configuration may be further characterized in that a plurality of the conductive bodies functioning as the second detection electrodes are provided, and at least two of the conductive bodies functioning as the second detection electrodes are electrically connected (the sixth configuration).

According to the sixth configuration, the number of lines can be reduced, and the electric power consumption can be further reduced.

Any one of the first to sixth configurations may be further characterized in that liquid crystal molecules in the liquid crystal layer have positive dielectric anisotropy (the seventh configuration).

### EMBODIMENT

The following description describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of part of constituent members is omitted. Further, the dimension ratios of the constituent members illustrated in the drawings do not necessarily indicate the real dimension ratios.

Embodiments are described below with reference to examples in which a liquid crystal display device is used as a display device, but the display device is not limited to a liquid crystal display device. Another display device such as an organic EL display device can be used.

### Embodiment 1

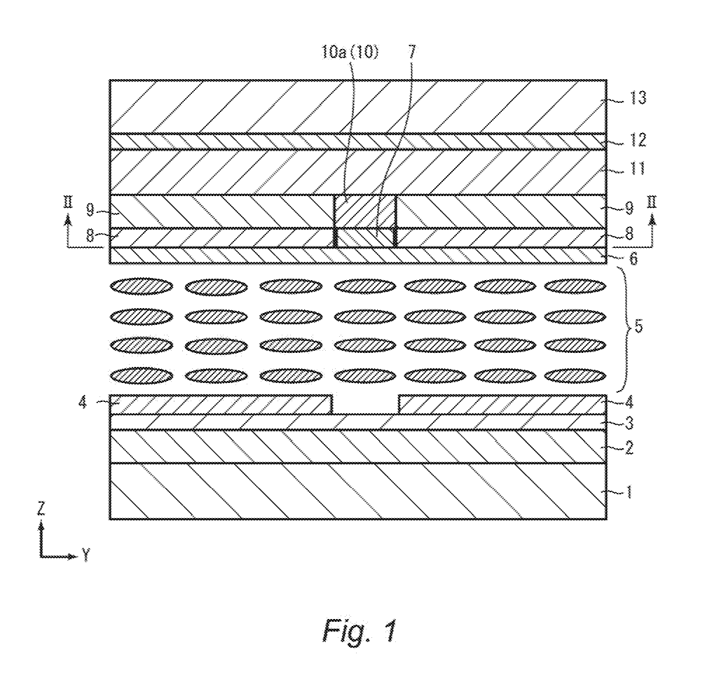

FIG. 1 illustrates a cross-sectional structure of principal parts of a touch-sensor-equipped liquid crystal display device in Embodiment 1. The touch-sensor-equipped liquid crystal display device in the present embodiment includes a thin film transistor (TFT) substrate (electrode substrate) 1, a common electrode 2, an insulating film 3, pixel electrodes 4, a liquid crystal layer 5, an insulating film 6, drive electrodes 7, dummy electrodes 8, color filters 9, a black matrix 10, a color filter substrate 11, detection electrodes 12, and a counter substrate 13. In the case of this touch-sensor-equipped liquid crystal display device, the side on which the counter substrate is provided is the front side, and the side on which the TFT substrate 1 is provided is the back side.

The TFT substrate 1 is made of, for example, glass. Further, the counter substrate 13, provided on an outer side so as to be opposed to the TFT substrate 1, is made of, for example, glass.

On the TFT substrate 1, the common electrode 2 and a plurality of the pixel electrodes 4 are provided. More specifically, the common electrode 2 is provided on the TFT substrate 1, and the plurality of pixel electrodes 4 are arranged in matrix on the common electrode 2 with the insulating film 3 being interposed therebetween. The configuration, however, may be such that the pixel electrodes 4 are provided on the TFT substrate 1, and the common electrode 2 is provided on the pixel electrodes 4 with the insulating film 3 being interposed therebetween.

The liquid crystal layer 5 is provided between the TFT substrate 1 and the color filter substrate 11. The liquid crystal layer 5 contains liquid crystal molecules that are a substance whose optical properties change in response to the application of an electric field to between the pixel electrodes 4 and the common electrode 2. In the present embodiment, the liquid crystal molecules have positive dielectric anisotropy. The liquid crystal molecules, however, may have negative dielectric anisotropy. The method for driving liquid crystal is the horizontal electric field driving method, which is, for example, IPS. The method for driving liquid crystal, however, is not limited to IPS, and it may be, for example, FFS, or the like.

On the color filter substrate 11, the color filters 9 and the black matrix 10 are formed. The color filters 9 are filters of three colors of red (R), green (G), and blue (B) that are regularly arrayed at positions corresponding to the pixel electrodes 4. The black matrix 10 as a light-shielding layer have openings at positions corresponding to the pixel electrodes 4.

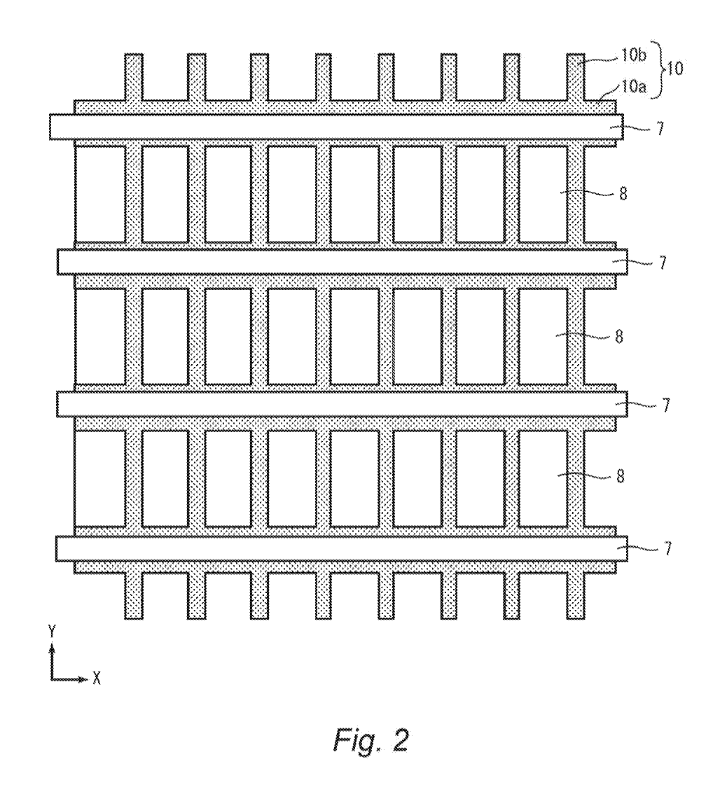

The black matrix 10 is provided so as to surround the color filters 9. In other words, the black matrix 10 is composed of portions 10a that extend in a first direction (the horizontal direction, or the X axis direction), and portions 10b that extend in a second direction intersecting at right angles with the first direction (the vertical direction, or the Y axis direction), when viewed in a plan view (see FIG. 2).

The drive electrodes 7 and the detection electrodes 12 compose pairs of touch sensor electrodes for electrostatic-capacitance-type touch sensors (hereinafter also simply referred to as touch sensors)

The drive electrodes 7 are arranged under the black matrix 10 (on the back side), between the liquid crystal layer 5 and the color filter substrate 11. By forming the drive electrode 7 in the form of thin lines arranged under the black matrix 10, the load capacity can be reduced as compared with a case where a drive electrode is formed over an entire surface of the substrate, whereby the response time constant can be decreased. This makes it possible to improve the response speed of the touch sensors. Further, since the drive electrodes 7 are arranged under the black matrix 10, the drive electrodes 7 do not have to be transparent electrodes, and can be formed with a metal having high conductivity. With this configuration, the response speed of the touch sensors is improved.

Between the drive electrodes 7 and the liquid crystal layer 5, the insulating film 6 is provided. The insulating film 6 functions to shield the detection electrodes 12 and the common electrode 2 from the other. The insulating film 6 may be made of an organic material, or may be made of an inorganic material.

FIG. 2 is a diagram for explaining positions at which the drive electrodes 7 are arranged, and is a cross-sectional view taken along line II-II in FIG. 1. FIG. 2, however, illustrates a range wider than that in FIG. 1.

The drive electrodes 7 are arranged under the portions 10a extending in the first direction of the black matrix 10 (the X axis direction). In other words, a plurality of the drive electrodes 7, each of which extends in the first direction, are arrayed in the second direction (the Y axis direction).

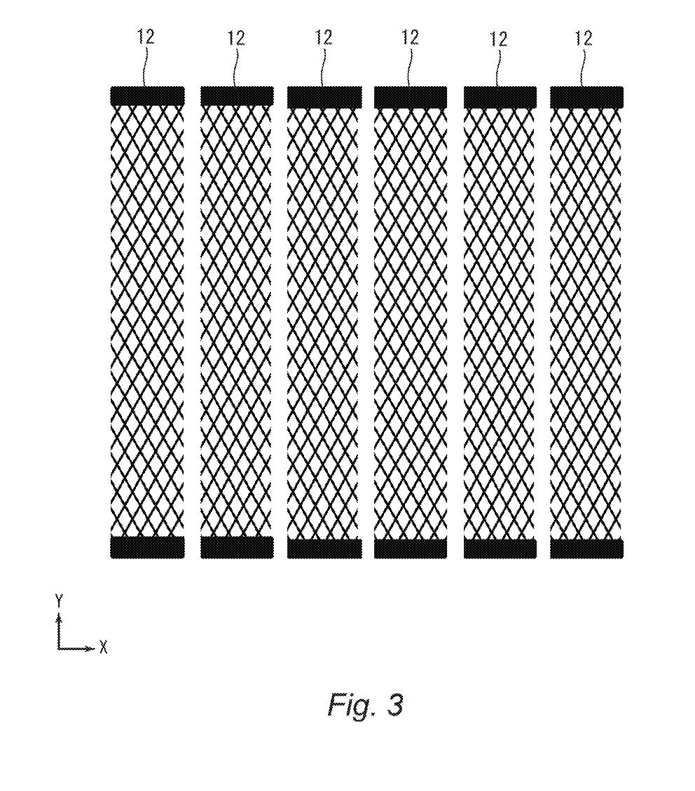

Each detection electrode 12 is an electrode that is paired with the drive electrode 7 and is intended to detect a change in the electrostatic capacitance formed between the same and the drive electrode 7. These detection electrodes 12 are arranged on an outer side (on the front side) of the color filter substrate 11 and between the color filter substrate 11 and the counter substrate 13. Each detection electrode 12 extends in the second direction (the vertical direction), and a plurality of the detection electrodes 12 are arrayed in the first direction (the horizontal direction), when the touch-sensor-equipped liquid crystal display device is viewed in a plan view. The detection electrodes 12 are, for example, mesh-type electrodes or transparent electrodes formed with a material such as indium tin oxide (ITO), so that a displayed image can be seen with the eyes. FIG. 3 is a top view in a case where the detection electrodes 12 are mesh-type electrodes.

The following description briefly describes a method for detecting a touched position with the touch sensors. Input signals are input to the drive electrodes 7 by sequentially scanning the same, and output signals are detected, which are output from the detection electrodes 12. When any area in the surface of the touch-sensor-equipped liquid crystal display device is touched, the electrostatic capacitance between the drive electrode 7 and the detection electrode 12 at the position changes. Based on the output signal output from the detection electrode 12, the position at which the electrostatic capacitance has changed is detected, and the position thus detected is identified as a touch position.

Between the liquid crystal layer 5 and the detection electrodes 12, and under the color filters 9, a plurality of dummy electrodes 8, which are conductive bodies, are arranged. In the present embodiment, the dummy electrodes 8 are arranged in the same layer in the stacking direction as the layer where the drive electrodes 7 are arrange. The dummy electrodes 8 are not connected with the other lines or electrodes, thereby being in a state of electrically floating. The dummy electrodes 8, however, may be grounded, or a voltage may be applied to the dummy electrodes 8.

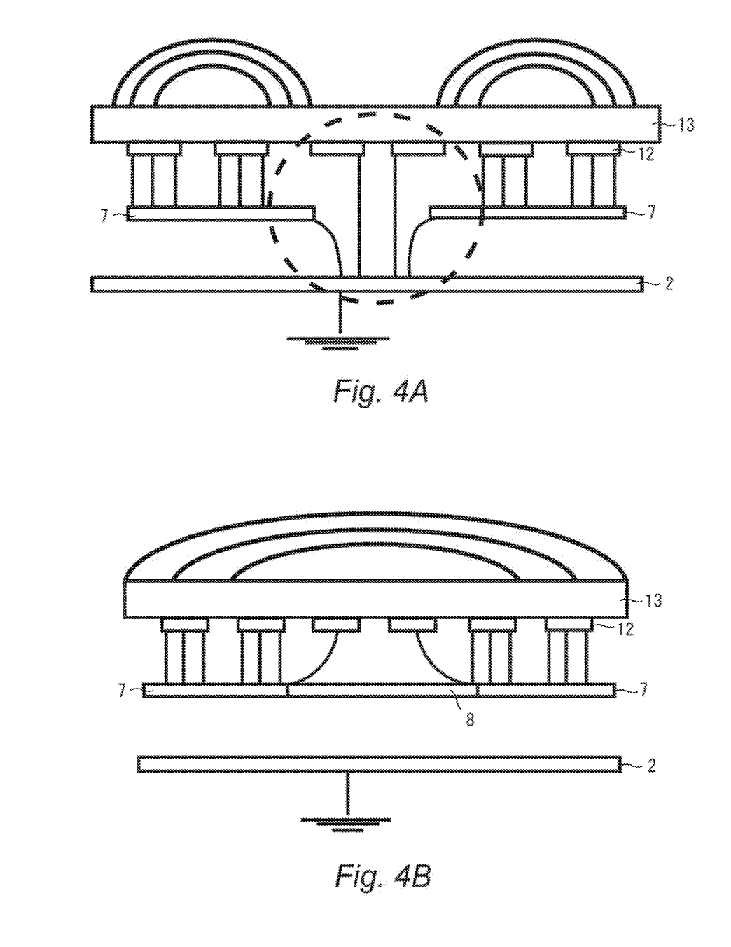

FIG. 4A schematically illustrates an electric field (lines of electric force) that is formed in a case where no dummy electrode 8 is provided. Further, FIG. 4B schematically illustrates an electric field that is formed in a case where the dummy electrodes 8 are provided. In FIGS. 4A and 4B, in order to schematically illustrate an electric field formed in a case where the dummy electrodes 8 are provided and an electric field formed in a case where no dummy electrode 8 is provided, the illustration of configurations other than the common electrode 2, the drive electrodes 7, the detection electrodes 12, and the counter substrate 13 is omitted.

As illustrated in FIG. 4A, in a case where no dummy electrode 8 is provided, an electric field is generated in an area between adjacent ones of the drive electrodes 7, that is, in a space between the detection electrode 12 and the common electrode 2 with the color filters 9 being interposed therebetween. The electric field, therefore, is applied to the liquid crystal layer 5 arranged between the detection electrodes 12 and the common electrode 2. Influences thereof are therefore possibly exerted to the display of images, whereby the image quality can be degraded.

On the other hand, in a case where the dummy electrodes 8 are provided between adjacent ones of the drive electrodes 7 as is the case with the present embodiment, the dummy electrodes 8 function to shield the detection electrodes 12 and the common electrode 2 from each other, as illustrated in FIG. 4B. This allows no electric field to be formed between the detection electrodes 12 and the common electrode 2. This makes it possible to prevent any electric field from being applied to the liquid crystal layer 5, due to an electric field formed between the detection electrodes 12 and the common electrode 2, thereby making it possible to suppress the degradation of the image quality.

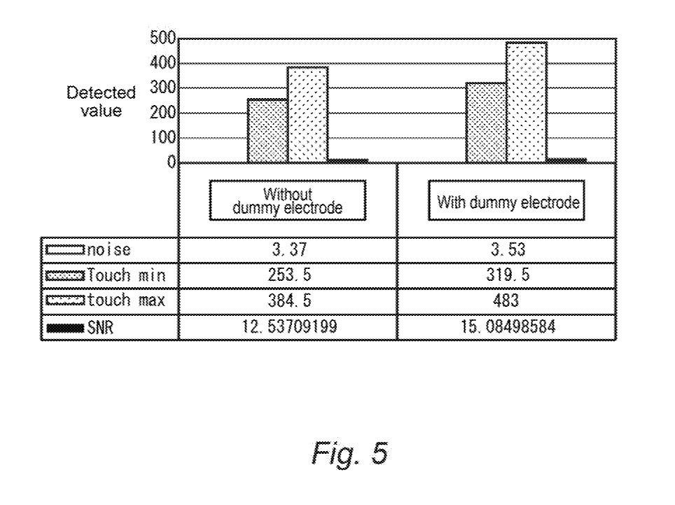

FIG. 5 illustrates data obtained by experiments of the magnitudes of signals detected by the touch sensors, to show differences between the case where the dummy electrodes 8 are provided and the case where no dummy electrode 8 is provided. FIG. 5 illustrate noises detected by the touch sensors, the maximum values of the signal detected by the touch sensors, the minimum values of the signal detected by the touch sensors, and signal to noise ratios (SNR).

There is approximately no difference between the magnitude of noise detected by the touch sensors in a case where no dummy electrode 8 was provided, and that in a case where the dummy electrodes 8 were provided. The maximum value and the minimum value of the signal detected in the case where the dummy electrodes 8 were provided are respectively greater than those in the other case. The SNR is therefore greater in the case where the dummy electrodes 8 were provided, as compared with the case where no dummy electrode 8 was provided.

### Embodiment 2

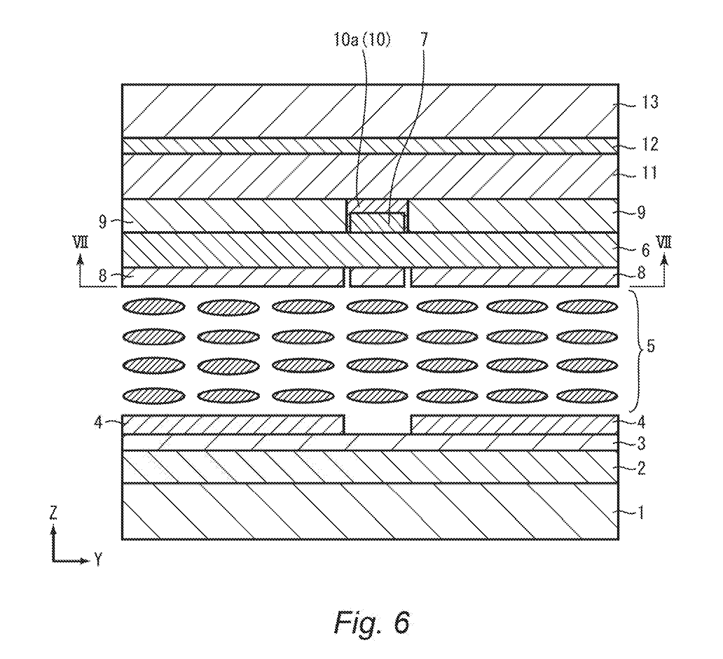

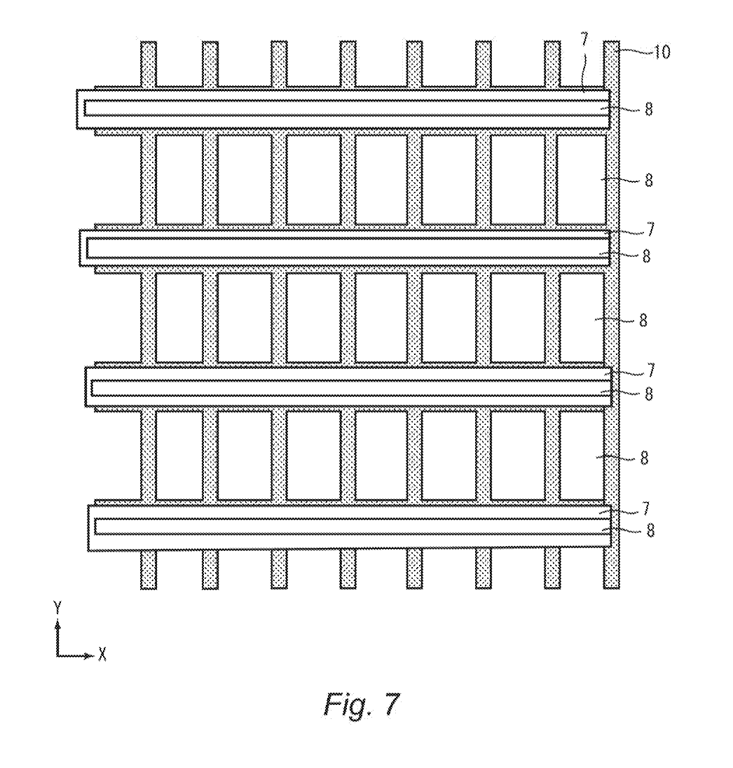

FIG. 6 illustrates a cross-sectional structure of principal parts of a touch-sensor-equipped liquid crystal display device in Embodiment 2. Further, FIG. 7 is a cross-sectional view taken along line VII-VII in FIG. 6. FIG. 7, however, illustrates a wider range than the range illustrated in FIG. 6.

In the touch-sensor-equipped liquid crystal display device in Embodiment 2, the dummy electrodes 8 are provided in a layer different from the layer where the drive electrodes 7 are provided. More specifically, the dummy electrodes 8 are arranged under the color filters 9, and between the insulating film 6 and the liquid crystal layer 5. In other words, the insulating film 6 is arranged between the dummy electrodes 8 and the color filters 9. The insulating film 6 functions to shield the detection electrodes 12 and the common electrode 2 from each other.

As illustrated in FIGS. 6 and 7, the dummy electrodes 8 are arranged, not only under the color filters 9, but also under the drive electrodes 7. The dummy electrodes 8 arranged under the drive electrodes 7 function to shield the drive electrodes 7 and the common electrode 2 from each other.

In the touch-sensor-equipped liquid crystal display device in Embodiment 2 as well, the drive electrodes 7 are arranged under the black matrix 10 as is the case with the touch-sensor-equipped liquid crystal display device in Embodiment 1. The makes it possible to reduce load capacity as compared with the configuration in which the drive electrode is a flat-plate-type electrode, thereby reducing the response time constant, and therefore improving the response speed of the touch sensors. Further, since the dummy electrodes 8 are arranged between the color filters 9 and the liquid crystal layer 5, the dummy electrodes 8 function to shield the detection electrodes 12 and the common electrode 2 from each other. This makes it possible to prevent any electric field from being applied to the liquid crystal layer 5, due to an electric field formed between the detection electrodes 12 and the common electrode 2, thereby making it possible to suppress the degradation of the image quality.

### Modification Example of Embodiment 2

The configuration may be such that the dummy electrodes 8 are arranged between the insulating film 6 and the liquid crystal layer 5, and only under the color filters 9.

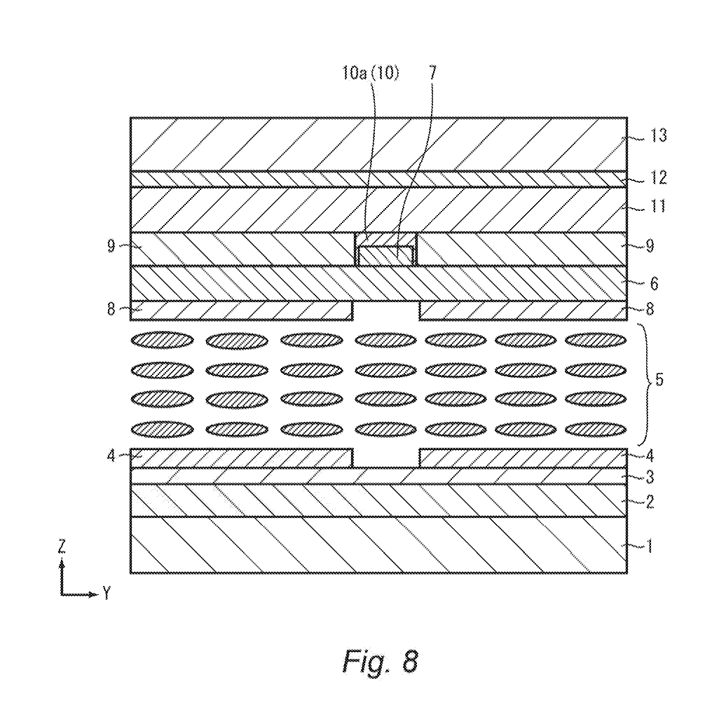

FIG. 8 illustrates a cross-sectional structure of principal parts of a modification configuration of the touch-sensor-equipped liquid crystal display device in Embodiment 2. In the exemplary modification configuration illustrated in FIG. 8, the dummy electrodes 8 are arranged between the insulating film 6 and the liquid crystal layer 5, and under the color filters 9, but are not arranged under the drive electrodes 7. In this configuration as well, the response speed of the touch sensors can be improved, without the degradation of the image quality.

### Embodiment 3

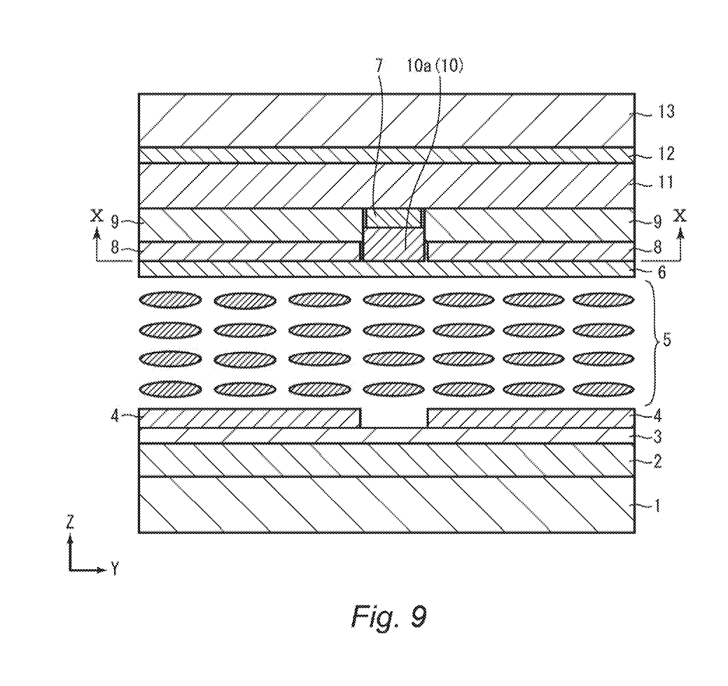

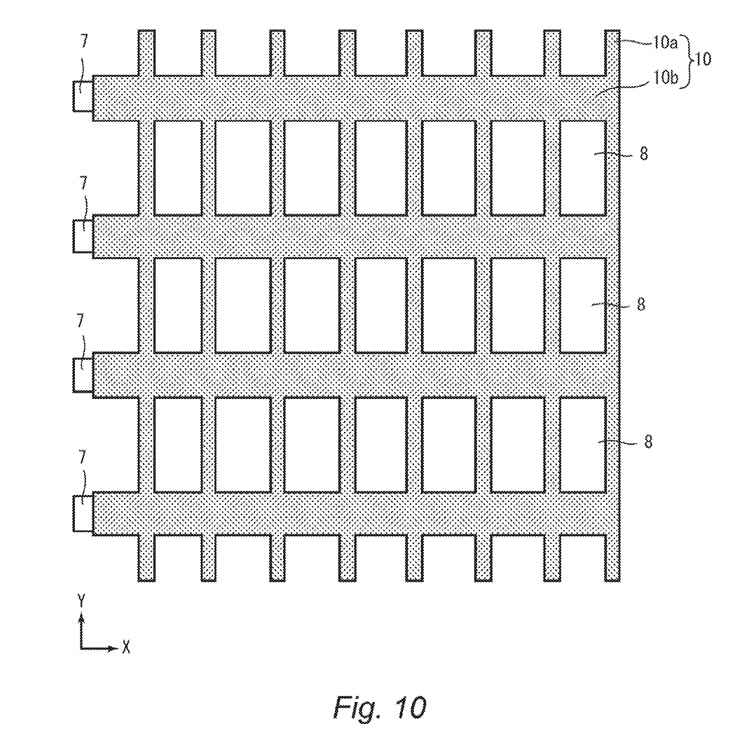

FIG. 9 illustrates a cross-sectional structure of principal parts of a touch-sensor-equipped liquid crystal display device in Embodiment 3. FIG. 10 is a cross-sectional view taken along line X-X in FIG. 9. FIG. 10, however, illustrates a wider range than that in FIG. 9.

In the touch-sensor-equipped liquid crystal display device in Embodiment 3, the drive electrodes 7 are arranged between the black matrix 10 and the color filter substrate 11, that is, on the black matrix 10.

The dummy electrodes 8 are arranged under the color filters 9, and between the color filters 9 and the insulating film 6.

In the case of the touch-sensor-equipped liquid crystal display device in Embodiment 3, since the drive electrodes 7 are arranged on the black matrix 10, the load capacity can be reduced, as compared with the configuration in which the drive electrode is a flat-plate-type electrode, whereby the response time constant can be decreased. This makes it possible to improve the response speed of the touch sensors. Further, since the dummy electrodes 8 are arranged between the color filters 9 and the liquid crystal layer 5, the dummy electrodes 8 function to shield the detection electrodes 12 and the common electrode 2 from each other. This prevents an electric field from being applied to the liquid crystal layer 5 due to electric fields formed between the detection electrodes 12 and the common electrode 2, whereby the degradation of image quality can be suppressed.

### Modification Configuration of Embodiment 3

The dummy electrodes 8 may be arranged on the color filters 9.

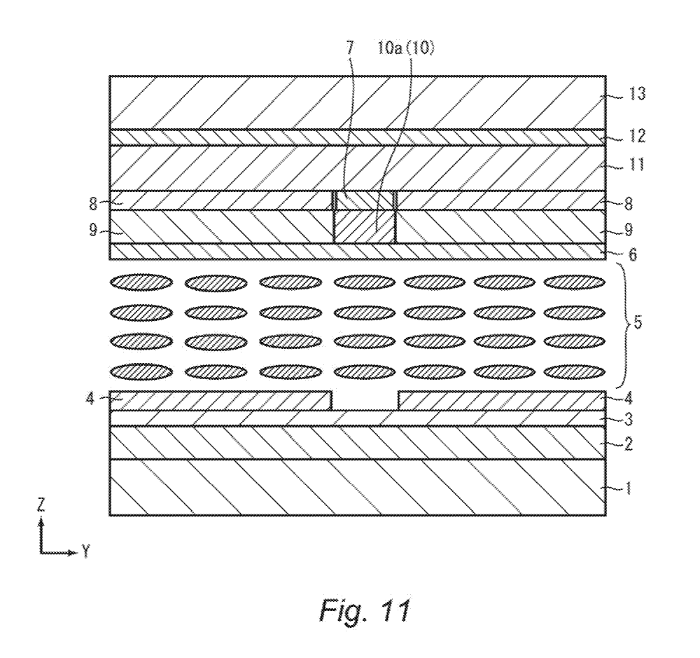

FIG. 11 illustrates a cross-sectional structure of principal parts of a modification configuration of the touch-sensor-equipped liquid crystal display device in Embodiment 3. In the exemplary modification configuration illustrated in FIG. 11, the dummy electrodes 8 are arranged on the color filters 9, and between the color filters 9 and the color filter substrate 11. The dummy electrodes 8, therefore, are provided between the drive electrodes 7 and the same layer.

In this configuration as well, the dummy electrodes 8, arranged between the detection electrodes 12 and the common electrode 2, function to shield the detection electrodes 12 and the common electrode 2 from each other. In other words, as is the case with the touch-sensor-equipped liquid crystal display device in Embodiment 3, the foregoing configuration makes it possible to improve the response speed of the touch sensors, without the degradation of the image quality.

### Embodiment 4

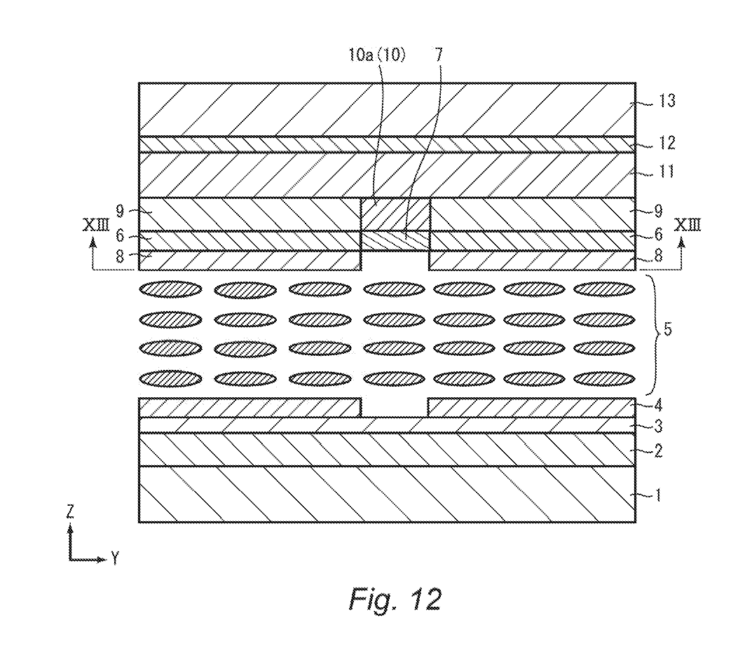

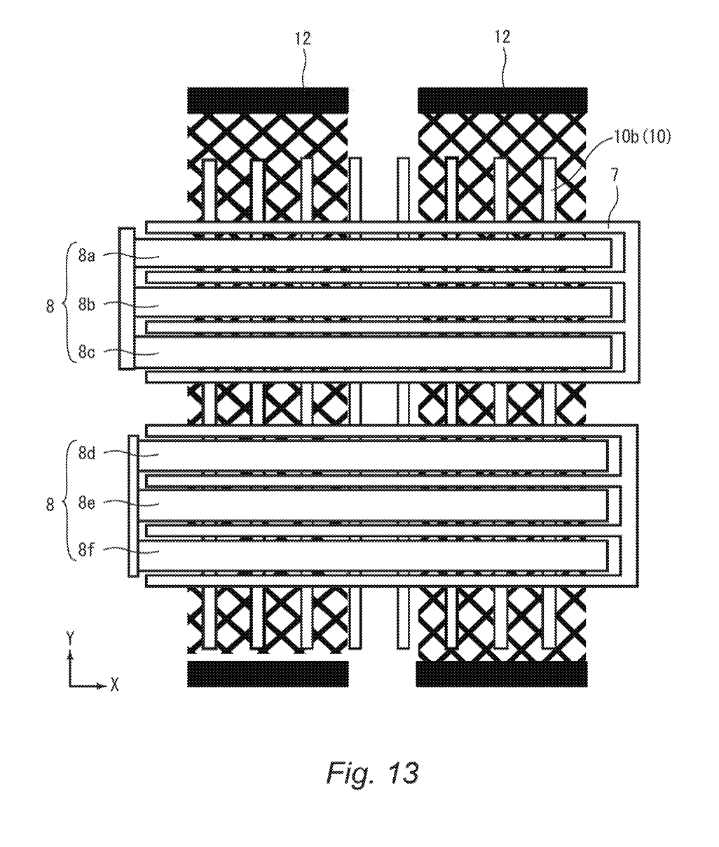

FIG. 12 illustrates a cross-sectional structure of principal parts of a touch-sensor-equipped liquid crystal display device in Embodiment 4. Further, FIG. 13 is a cross-sectional view taken along line XIII-XIII in FIG. 12. FIG. 13, however, illustrates a wider range than that in FIG. 12.

The drive electrodes 7 are arranged between the black matrix 10 and the liquid crystal layer 5, under the black matrix 10.

The dummy electrodes 8 are arranged between the insulating film 6 and the liquid crystal layer 5. As illustrated in FIG. 13, a plurality of the dummy electrodes 8, extend in the first direction (the horizontal direction) like the drive electrodes 7, and are arrayed in the second direction (the vertical direction). In the stacking direction, the dummy electrodes 8 are provided in a layer different from the layer where the drive electrodes 7 are arrayed. In a plan view, however, the dummy electrodes 8 are provided between adjacent ones of the drive electrodes 7, as illustrated in FIG. 13.

No dummy electrode 8 is arranged under the drive electrodes 7, as illustrated in FIG. 12, but the dummy electrodes 8 may be arranged under the drive electrodes 7.

In FIG. 13, three adjacent dummy electrodes 8a, 8b, and 8c are electrically connected with one another. Further, three adjacent dummy electrodes 8d, 8e, and 8f electrically connected with one another.

In the present embodiment, the dummy electrodes 8 are used also as detection electrodes of the touch sensors. More specifically, the dummy electrodes 8 are paired with the drive electrodes 7, and function as the detection electrodes for detecting changes in electrostatic capacitances formed between the same and the drive electrodes 7. In the case where the dummy electrodes 8 are used as the detection electrodes of the touch sensors, signals are supplied to the drive electrodes 7, and output signals from the dummy electrodes 8 are detected. When a human finger, a touch pen, or the like approaches or comes into contact with the surface of the touch-sensor-equipped liquid crystal display device, the electrostatic capacitance between the dummy electrode 8 at the position where the object approaches or comes into contact and the drive electrode 7 adjacent thereto changes, causing the output signal from the dummy electrode 8 to change. In other words, by detecting a change in the output signal from the dummy electrode 8, it is detected that an object such as a human finger or a touch pen approaches or comes into contact with the surface of the touch-sensor-equipped liquid crystal display device.

In the above-described method, since both of the drive electrodes 7 and the dummy electrodes 8 extend in the first direction (the horizontal direction), the approach or the contact of an object can be detected, but a detailed position of the approach or the contact of the object cannot be identified. The electric power consumption, however, is smaller as compared with the method in which the drive electrodes 7 and the detection electrodes 12 are used as pairs of the touch sensor electrodes so that the detailed position of the contact of an object is identified. Besides, since the three adjacent dummy electrodes (8a, 8b, and 8c), (8d, 8e, 8f) are connected, the electric power consumption decreases, as compared with a case where respective output signals of the dummy electrodes 8 are detected.

In the touch-sensor-equipped liquid crystal display device in the present embodiment, therefore, the approach or the contact of an object is detected by using the drive electrodes 7 and the dummy electrodes 8, and when the approach or the contact of an object is detected, the detailed position of the contact of the object is identified by using the drive electrodes 7 and the detection electrodes 12 as pairs of touch sensor electrodes.

In the case of this method, the electric power consumption can be reduced, as compared with the method in which the contact of an object is detected by using the drive electrodes 7 and the detection electrodes 12 at all times. More specifically, until the approach or the contact of an object is detected, the drive electrodes 7 and the dummy electrodes 8 are used as the touch sensors, the electric power consumption can be reduced. Further, when the approach or the contact of an object is detected, the detailed position of the contact of the object can be detected by using the drive electrodes 7 and the detection electrodes 12 as the touch sensors.

### Modification Configuration of Embodiment 4

Though the three adjacent dummy electrodes 8a, 8b, and 8c are electrically connected with one another in the case of FIG. 13, the configuration may be, for example, such that only the dummy electrodes 8a and 8c are electrically connected with each other, and the dummy electrode 8b is not electrically connected with the dummy electrodes 8a and 8c. Likewise, of the three adjacent dummy electrodes 8d, 8e, and 8f, for example, only the dummy electrodes 8d and 8f are electrically connected with each other, and the dummy electrode 8e does not have to be electrically connected with the dummy electrodes 8d and 8f.

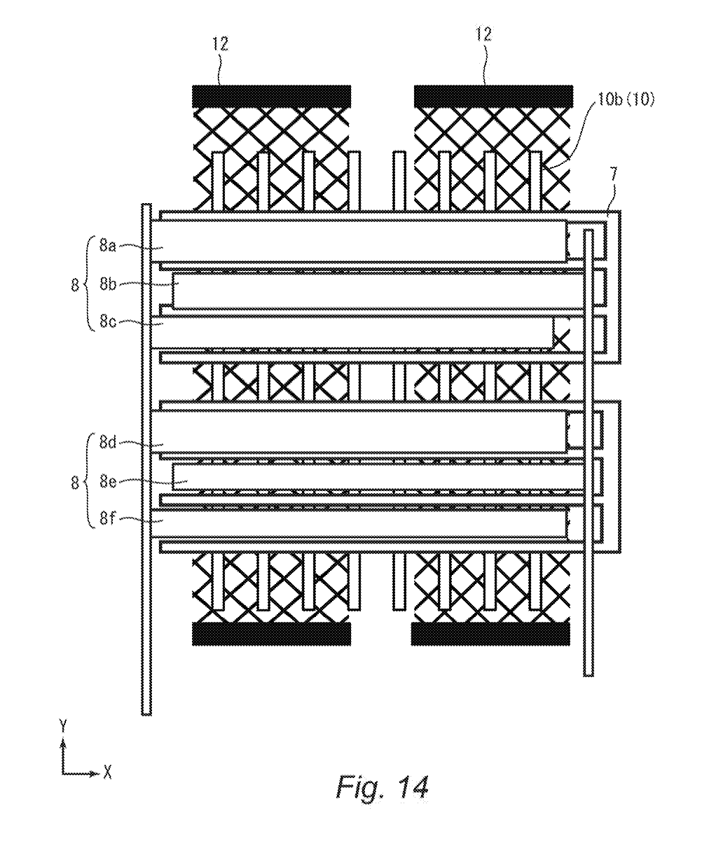

FIG. 14 illustrates a configuration in which, of the three adjacent dummy electrodes 8a, 8b, and 8c, only the dummy electrodes 8a and 8c are electrically connected, and of the three adjacent dummy electrodes 8d, 8e, and 8f, only the dummy electrodes 8d and 8f are electrically connected.

In a case where, of the three adjacent dummy electrodes 8a, 8b, and 8c, the dummy electrode 8b is not electrically connected with the dummy electrodes 8a and 8c as illustrated in FIG. 14, the detection can be performed by distinguishing the case where an object approaches or comes into contact at the position of the dummy electrode 8b, and the case where an object approaches or comes into contact at either one of the positions of the dummy electrodes 8a and 8c. For the three adjacent dummy electrodes 8d, 8e, and 8f as well, the detection can be performed by distinguishing the case where an object approaches or comes into contact at the position of the dummy electrode 8e, and the case where an object approaches or comes into contact at either one of the positions of the dummy electrodes 8d and 8f.

All of the three adjacent dummy electrodes 8a, 8b, and 8c do not have to be electrically connected with one another. In this case, the detection can be performed by distinguishing the case where an object approaches or comes into contact at the position of the dummy electrode 8a, the case where an object approaches or comes into contact at the position of the dummy electrode 8b, and the case where an object approaches or comes into contact at the position of the dummy electrode 8c. Likewise, all of the three adjacent dummy electrodes 8d, 8e, and 8f do not have to be electrically connected.

The present invention is not limited to the above-described embodiment. For example, in Embodiment 4, three adjacent dummy electrodes 8 are electrically connected, but two adjacent dummy electrodes 8 may be electrically connected, or four or more adjacent dummy electrodes may be electrically connected.

### DESCRIPTION OF REFERENCE NUMERALS

1: TFT substrate
2: common electrode
3: insulating film
4: pixel electrode
5: liquid crystal layer
6: insulating film
7: drive electrode
8: dummy electrode
9: color filter
10: black matrix
11: color filter substrate
12: detection electrode
13: counter substrate

1. A touch-sensor-equipped liquid crystal display device comprising:
an electrode substrate on which a common electrode and a plurality of pixel electrodes are provided;
a color filter substrate that is provided so as to be opposed to the electrode substrate, the color filter substrate including color filters formed at positions corresponding to the pixel electrodes, respectively, and a black matrix having openings at positions corresponding to the pixel electrodes;
a liquid crystal layer provided between the electrode substrate and the color filter substrate;
a drive electrode that is arranged between the liquid crystal layer and the color filter substrate, on or under the black matrix;
a detection electrode that is paired with the drive electrode, for detecting a change in an electrostatic capacitance formed between the detection electrode and the drive electrode; and
a conductive body that is arranged between the liquid crystal layer and the detection electrode, on or under the color filters.

2. The touch-sensor-equipped liquid crystal display device according to claim 1, further comprising an insulator arranged between the color filter substrate and the liquid crystal layer.

3. The touch-sensor-equipped liquid crystal display device according to claim 1,
wherein the conductive body is provided in the same layer as that where the drive electrode is provided.

4. The touch-sensor-equipped liquid crystal display device according to claim 1,
wherein the conductive body is provided in a layer different from that where the drive electrode is provided.

5. The touch-sensor-equipped liquid crystal display device according to claim 1,
wherein the conductive body functions also as a second detection electrode that is paired with the drive electrode, for detecting a change in an electrostatic capacitance formed between the conductive body and the drive electrode.

6. The touch-sensor-equipped liquid crystal display device according to claim 5,
wherein a plurality of the conductive bodies functioning as the second detection electrodes are provided, and at least two of the conductive bodies functioning as the second detection electrodes are electrically connected.

7. The touch-sensor-equipped liquid crystal display device according to claim 1,
wherein liquid crystal molecules in the liquid crystal layer have positive dielectric anisotropy.
